(19) United States
(12) Patent Application Publication
(10) Pub. No.: US 2014/0286391 A1
(43) Pub. Date: Sep. 25, 2014

(54) SAMPLE ADAPTIVE OFFSET (SAO) PROCESSING APPARATUS REUSING INPUT BUFFER AND OPERATION METHOD OF THE SAO PROCESSING APPARATUS

(71) Applicants: KWANGWOON UNIVERSITY INDUSTRY-ACADEMIC COLLABORATION FOUNDATION, Seoul (KR); SAMSUNG ELECTRONICS CO., LTD., Suwon-si (KR)

(72) Inventors: Doo Hyun KIM, Seoul (KR); Dong Gyu Sim, Seoul (KR); Do Hyung Kim, Hwaseong-si (KR); Joon Ho Song, Hwaseong-si (KR); Eun Kyung Ryu, Seoul (KR); Shi Hwa Lee, Seoul (KR); Hyun Ho Cho, Seoul (KR); Jong Hun Yoo, Seoul (KR)

(73) Assignees: KWANGWOON UNIVERSITY INDUSTRY-ACADEMIC COLLABORATION FOUNDATION, Seoul (KR); SAMSUNG ELECTRONICS CO., LTD., Suwon-si (KR)

(21) Appl. No.: 14/153,547

(22) Filed: Jan. 13, 2014

(30) Foreign Application Priority Data
Mar. 25, 2013 (KR) 10-2013-0031367

(51) Int. Cl. H04N 19/117; H04N 19/156; H04N 19/182

(52) U.S. Cl. CPC H04N 19/00066; H04N 19/00303; H04N 19/00206
USPC 375/240.02

(57) ABSTRACT

A sample adaptive offset (SAO) processing apparatus reusing an input buffer and an operation method of the SAO processing apparatus may include a SAO parameter parser to parse SAO parameter information from a bitstream; a SAO parameter adjuster to extract SAO type information and offset information from the parsed SAO parameter information; and a filtering performer to perform filtering on the bitstream based on the SAO type information and the offset information.

### CROSS-REFERENCE TO RELATED APPLICATIONS

This application claims the priority benefit of Korean Patent Application No. 10-2013-0031367, filed on Mar. 25, 2013, in the Korean Intellectual Property Office, the disclosure of which is incorporated herein by reference.

### BACKGROUND

1. Field

One or more embodiments relate to a sample adaptive offset (SAO) processing apparatus to perform SAO processing within a largest coding unit (LCU) in the case of performing the SAO processing, and an operation method of the SAO processing apparatus.

2. Description of the Related Art

High efficiency video coding (HEVC) refers to a next generation video codec of which standardization is ongoing by joint collaborative team on video coding (JCT-VC) jointed by moving picture experts group (MPEG) and video coding experts group (VCEG).

HEVC may not perform coding based on a block unit with a fixed size, which is different from conventional video codec, such as H.264/advanced video coding (AVC), for example. To overcome an issue in that macro block unit coding of H.264/AVC may not effectively achieve an image at various resolutions due to the fixed size, HEVC defines a coding unit (CU), a transform unit (TU), a prediction unit (PU), and the like, and uses the CU as a basic coding unit. Here, a CU having the largest size among CUs may be referred to as a largest coding unit (LCU). An input image may be partitioned into a plurality of LCUs, and encoding and decoding may be performed based on an LCU.

HEVC may perform sample adaptive offset (SAO) processing based on an LCU and may enhance encoding efficiency by adding an offset to a predetermined pixel. An SAO may be classified into an edge offset (EO) and a band offset (BO) based on a process of selecting a pixel to be added with an offset. An EO method may select a neighbor pixel based on a SAO type, may classify pixels into four categories based on a difference value between pixels, and may add a corresponding offset to a pixel value of a pixel included in each category. The SAO may be in a form of a finite impulse response (FIR) filter. Therefore, when an offset is initially added to a reference pixel, the reference pixel may not be used as a reference pixel of a current pixel. Accordingly, there is a need to back up a pixel value prior to adding an offset to a reference pixel, or to pre-store a difference between a processing pixel and the reference pixel.

### SUMMARY

The foregoing and/or other aspects are achieved by providing a sample adaptive offset (SAO) processing apparatus, including: a SAO parameter parser to parse SAO parameter information from a bitstream; a SAO parameter adjuster to extract SAO type information and offset information from the parsed SAO parameter information; and a filtering performer to perform filtering on the bitstream based on the SAO type information and the offset information.

The SAO processing apparatus may further include a SAO buffer manager to receive the SAO type information, and to extract a reference line and a processing line of the bitstream. The filtering performer may perform filtering on the bitstream using the extracted reference line and processing line, together with the SAO type information and the offset information.

The SAO processing apparatus may further include a largest coding unit (LCU)/picture buffer to receive a request for pixel information required based on the SAO type information from the SAO buffer manager, and to load a reference pixel and a SAO processing pixel in response to the request.

The SAO buffer manager may determine whether a loaded pixel is the reference pixel or the SAO processing pixel, and may store the loaded pixel at a predetermined position of an input buffer based on the determination result.

The filtering performer may receive information associated with at least one of a reference pixel and a SAO processing pixel from the SAO buffer manager to determine a category of a current pixel.

The filtering performer may apply an offset corresponding to the determined category to the SAO processing pixel using an offset value transferred from the SAO parameter adjuster.

The SAO processing apparatus may further include a SAO output unit to display a pixel of the filtered bitstream on an output screen, and to store the pixel of the filtered bitstream in an LCU/picture buffer.

The SAO buffer manager may include a buffer management controller to determine whether an input to a buffer is to store a pixel moved from another input buffer or to store at least one of the reference pixel and the SAO processing pixel logged by the LCU/picture buffer.

The foregoing and/or other aspects are achieved by providing an operation method of a SAO processing apparatus, the method including parsing, using a SAO parameter parser, SAO parameter information from a bitstream; extracting, using a SAO parameter adjuster, SAO type information and offset information from the parsed SAO parameter information; performing filtering, using a filtering performer, on the bitstream based on the SAO type information and the offset information, and receiving, using a SAO buffer manager, the SAO type information to extract a reference line and a processing line of the bitstream. The filtering may include performing filtering on the bitstream using the extracted reference line and processing line, together with the SAO type information and the offset information.

The operation method of the SAO processing apparatus may further include receiving, using an LCU/picture buffer, a request for pixel information required based on the SAO type information from the SAO buffer manager, to load a reference pixel and a SAO processing pixel in response to the request.

The operation method of the SAO processing apparatus may further include determining, using the SAO buffer manager, whether a loaded pixel is the reference pixel or the SAO processing pixel; and storing the loaded pixel at a predetermined position of an input buffer based on the determination result.

The operation method of the SAO processing apparatus may further include receiving, using the filtering performer, information associated with at least one of a reference pixel and a SAO processing pixel from the SAO buffer manager to determine a category of a current pixel.

The operation method of the SAO processing apparatus may further include applying, using the filtering performer, an offset corresponding to the determined category to the SAO processing pixel using an offset value transferred from the SAO parameter adjuster.

The operation method of the SAO processing apparatus may further include displaying, using a SAO output unit, a pixel of the filtered bitstream on an output screen to store the pixel of the filtered bitstream in an LCU/picture buffer.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a sample adaptive offset (SAO) processing apparatus according to an embodiment;

FIG. 2 illustrates a configuration of a SAO buffer manager according to an embodiment;

FIG. 3 illustrates a diagram to describe a function of a SAO buffer manager according to an embodiment;

FIG. 4 illustrates a diagram to describe a SAO processing unit used by a SAO processing apparatus according to an embodiment;

FIGS. 5A through 5D illustrate diagrams to describe an example of performing SAO processing by backing up a pixel and a code value in response to a SAO processed pixel being selected as a reference pixel in the case of performing SAO processing based on a line unit according to an embodiment;

FIG. 6 illustrates an operation method of a SAO processing apparatus according to an embodiment; and

FIG. 7 illustrates a method of performing SAO buffer management based on a SAO type according to an embodiment.

### DETAILED DESCRIPTION

Reference will now be made in detail to embodiments, examples of which are illustrated in the accompanying drawings, wherein like reference numerals refer to like components throughout. Embodiments are described below to explain the present disclosure by referring to the figures.

When it is determined detailed description related to a related known function or configuration they may make the purpose of embodiments unnecessarily ambiguous in describing embodiments, the detailed description will be omitted here. Also, terminologies used herein are defined to appropriately describe embodiments and thus, may be changed depending on a user, the intent of an operator, or a custom. Accordingly, the terminologies must be defined based on the following overall description of this specification.

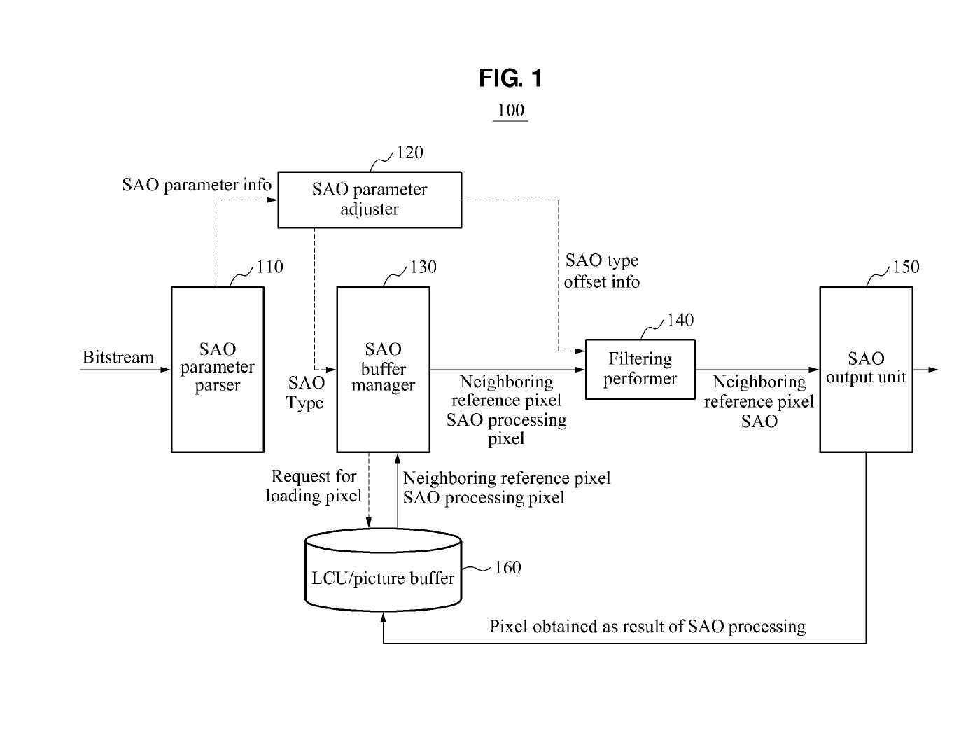

FIG. 1 illustrates a sample adaptive offset (SAO) processing apparatus 100 according to an embodiment.

When a current input pixel is reusable as a reference pixel or a processing pixel by separating a buffer of the current input pixel into an input buffer and an output buffer, the SAO processing apparatus 100 may reuse a pixel value by transferring the current input pixel to an input buffer of subsequent processing. Accordingly, system efficiency may be enhanced by decreasing the number of memory loads.

When performing SAO processing based on a largest coding unit (LCU) line unit, a line unit input reference pixel may be used as a subsequent line input processing pixel. Accordingly, the SAO processing apparatus 100 may reuse a pixel value by duplicating a value of an input buffer of a reference pixel to an input buffer of a processing pixel. The SAO processing apparatus 100 may quickly perform SAO processing by minimizing latency in a memory load through the above buffer management.

Referring to FIG. 1, the SAO processing apparatus 100 may include a SAO parameter parser 110, a SAO parameter adjuster 120, a SAO buffer manager 130, a filtering performer 140, a SAO output unit 150, and an LCU/picture buffer 160.

The SAO parameter parser 110 may parse SAO parameter information from a bitstream.

The SAO parameter adjuster 120 may extract SAO type information and offset information from the parsed SAO parameter information. The SAO buffer manager 130 may receive the SAO type information, and may extract a reference line and a processing line of the bitstream. For example, the SAO parameter adjuster 120 may notify the SAO buffer manager 130 of SAO type information. Also, the SAO parameter adjuster 120 may notify the filtering performer 140 of SAO type information and offset information to perform filtering.

The SAO buffer manager 130 may determine whether a loaded pixel is the reference pixel or the SAO processing pixel. The SAO buffer manager 130 may store the loaded pixel at a predetermined position of an input buffer based on the determination result.

Although not illustrated, the SAO buffer manager 130 may include a buffer management controller.

The buffer management controller may determine whether an input to a buffer is to store a pixel moved from another input buffer or to store at least one of the reference pixel and the SAO processing pixel logged by the LCU/picture buffer 160.

The filtering performer 140 may perform filtering on the bitstream based on the SAO type information and the offset information.

The filtering performer 140 may perform filtering on the bitstream using the extracted reference line and processing line, together with the SAO type information and the offset information.

The filtering performer 140 may receive information associated with at least one of a reference pixel and a SAO processing pixel from the SAO buffer manager 130 to determine a category of a current pixel. The filtering performer 140 may apply an offset corresponding to the determined category to the SAO processing pixel using an offset value transferred from the SAO parameter adjuster 120. For example, the filtering performer 140 may receive information associated with the reference pixel and the SAO processing pixel transmitted from the SAO buffer manager 130, to determine the category of the current pixel, and may add an offset corresponding to the determined category to the processing pixel using the offset value transmitted from the SAO parameter adjuster 120.

The SAO output unit 150 may display a pixel of the filtered bitstream on an output screen, and may also store the pixel of the filtered bitstream in the LCU/picture buffer 160. For example, the filtering performer 140 may transmit an added pixel to the SAO output unit 150. The SAO output unit 150 may store a filtered pixel in the output screen and the LCU/picture buffer 160.

The LCU/picture buffer 160 may receive a request for pixel information required based on the SAO type information from the SAO buffer manager 130, and may load a reference pixel and a SAO processing pixel in response to the request.

The SAO may be in a form of a finite impulse response (FIR) filter, and a value before SAO processing is performed may be used as a reference pixel in the case of calculating a category for offset decision. That is, a SAO processed neighbor pixel may not be used as a reference pixel for SAO processing of a current position.

In the case of performing SAO processing within an LCU, the SAO processing apparatus 100 may process a neighbor reference pixel and a processing pixel as an input. Accordingly, the SAO processing apparatus 100 may reuse a previously used input pixel as a reference pixel and a processing pixel to be used for SAO processing of a subsequent line. To this end, the SAO processing apparatus 100 may decrease memory load and minimize latency by moving a pixel to be reused to a corresponding buffer through buffer management and thus, may quickly perform SAO processing.

The SAO processing apparatus 100 may decrease the memory load by distinguishing an input buffer and an output buffer of the SAO, and by moving a value to an input buffer of a corresponding position when a pixel value stored in the input buffer is reusable. Since the memory load is decreased, a system processing rate may be enhanced.

In the case of performing filtering on a pixel of a current line and then performing filtering on a pixel of a subsequent line based on a SAO type, the SAO processing apparatus 100 may use an input of a previous processing pixel as a subsequent reference pixel. Accordingly, in the case of duplicating a pixel value from an input buffer of a reference pixel to an input buffer of a processing pixel, the memory load may be minimized by reusing the pixel value to be fetched from a memory.

The SAO processing apparatus 100 may be included in constituent components of a high efficiency video coding (HEVC) video decoder.

The HEVC video decoder may include an entropy decoding unit, a resorting unit, an inverse quantization unit, an inverse discrete cosine transform (IDCT) unit, a motion compensation unit, an in-screen prediction unit, and a SAO processing unit.

A function of the SAO processing apparatus 100 may be applied to the SAO processing unit.

The HEVC video decoder may parse required context information from a bitstream using the entropy decoding unit. Parsed quantization coefficients may be resorted using the resorting unit. The inverse-quantization unit may perform inverse quantization on the resorted quantization coefficients, and the IDCT unit may perform IDCT on an output value of the inverse-quantization unit.

A decoded differential pixel value that is an output of the IDCT unit and a prediction value generated by the motion compensation unit or the in-screen prediction unit may be added to create a decoded image before filtering is performed. The decoded image before filtering is performed may be filtered using the SAO processing unit. The filtered image may be used for an output of the HEVC video decoder and an inter-screen prediction process of a subsequent image.

The HEVC video decoder applied with the SAO processing apparatus 100 may partition a frame or a slice based on an LCU, and may perform SAO processing for each LCU. When the SAO processing is performed based on the LCU, filtering may be performed by referring to reference pixels positioned in eight directions from a current position of an LCU, based on a SAO type. Due to a FIR filter characteristic of the SAO, a pixel value in which SAO processing is not performed may be used as a reference pixel.

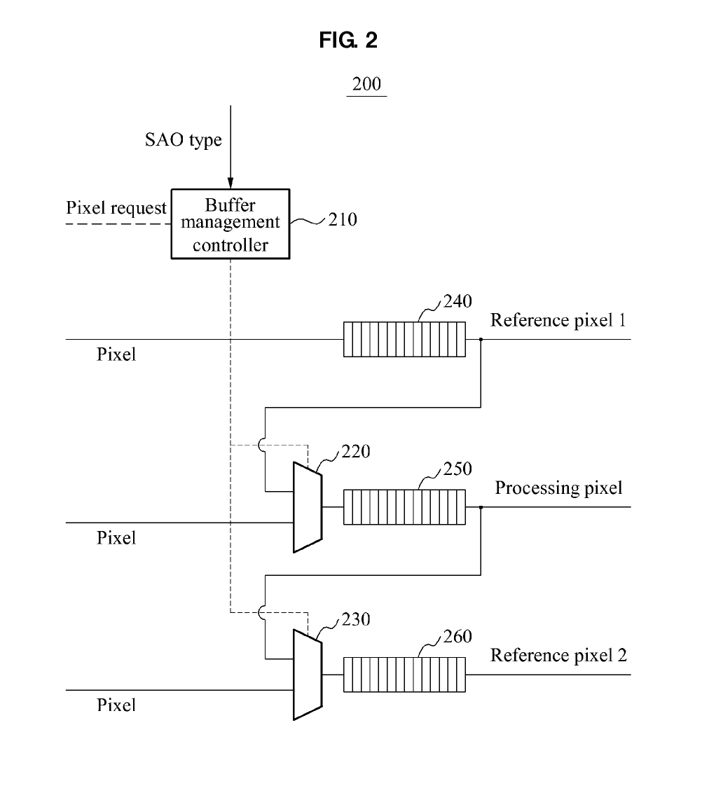

FIG. 2 illustrates a configuration of a SAO buffer manager 200 according to an embodiment.

The SAO buffer manager 200 may efficiently manage a buffer by reusing an input pixel required for SAO processing. The SAO buffer manager 200 may include a buffer management controller 210.

The buffer management controller 210 may determine whether an input to a buffer is to store a pixel moved from another input buffer.

The buffer management controller 210 may determine whether an input to a buffer is to store at least one of a reference pixel and a SAO processing pixel logged by an LCU/picture buffer.

For example, when SAO types include 45 degrees, 135 degrees, and 90 degrees, the SAO buffer manager 200 may perform SAO processing by referring to lines positioned above and below a current processing line.

Accordingly, when an input buffer and an output buffer are separate from each other, the SAO buffer manager 200 may reuse a portion of pixel values stored in the input buffer as a reference pixel for subsequent processing. In FIG. 2, buffers 240, 250, and 260 may be input buffers. In the case of reusing a pixel value of the input buffer, whether a pixel corresponds to a reference pixel or a processing pixel may vary. Accordingly, a pixel value may be moved to a buffer of a corresponding position through data transmission between buffers.

The buffer management controller 210 may determine whether an input to a buffer is to store a pixel moved from another input buffer or to store a pixel value obtained through the LCU/picture buffer. The buffer management controller 210 may control multiplexers 220 and 230 using a control signal with respect to the determination, and may control an operation of the SAO buffer manager 200.

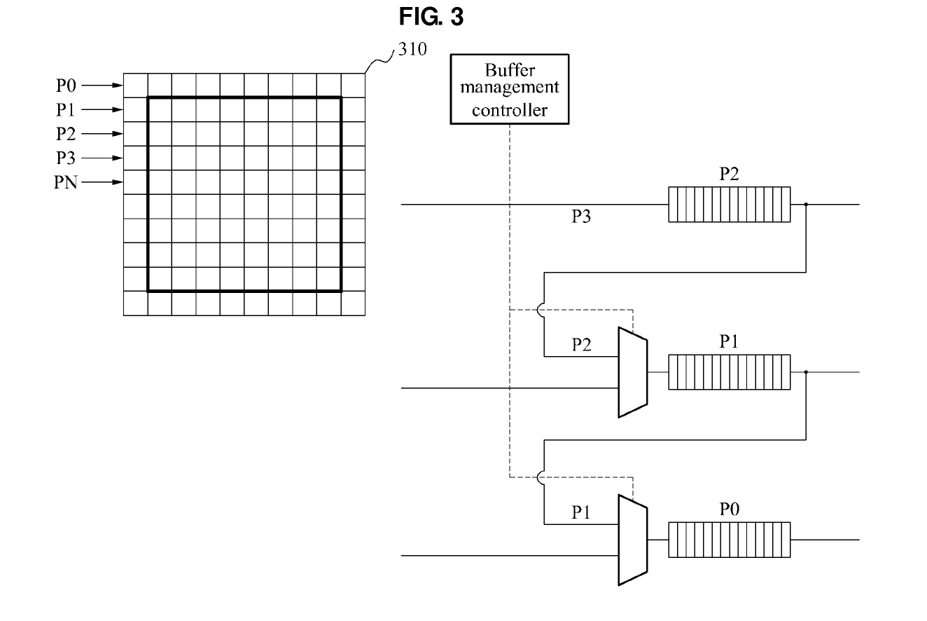

FIG. 3 illustrates a diagram to describe a function of a SAO buffer manager 310 according to an embodiment.

Description about each line may be displayed on the SAO buffer manager 310.

P0 may be interpreted as an upper line of an LCU of a current position.

P1 may be interpreted as a first line of the LCU of the current position.

P2 may be interpreted as a lower line of P1.

Hereinafter, an example of a movement path of a pixel of an input buffer of the SAO buffer manager 310 according to an embodiment will be described.

Initially, when a SAO type is 90 degrees, P0, P1, and P2 may be input to a buffer in order to filter a pixel of a P1 position. When the pixel of the P1 position is filtered, filtering may be performed on a pixel of a P2 position. In this example, P1, P2, and P3 may be input. P1 and P2 are present within an input buffer and thus, may move to a corresponding position of the input buffer through data movement.

P3 having been absent within the input buffer may be stored in the input buffer through memory load. Accordingly, all of P1, P2, and P3 may be present within the input buffer and thus, a filtering performer may perform filtering on the pixel of the P2 position using a pixel value of the input buffer.

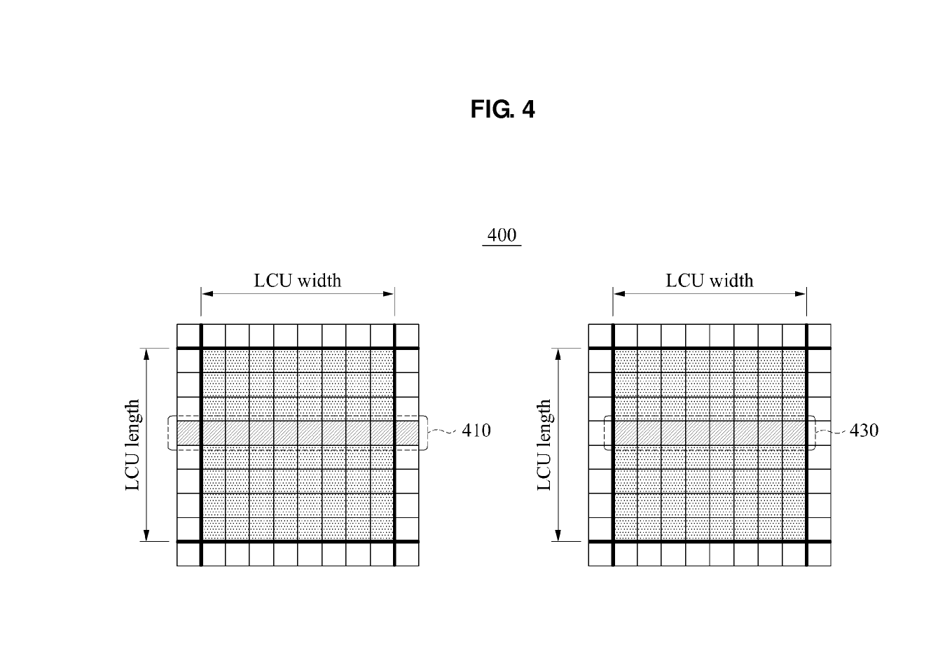

FIG. 4 illustrates a diagram 400 to describe a SAO processing unit used by a SAO processing apparatus according to an embodiment.

Referring to FIG. 4, the SAO processing unit according to an embodiment may be defined.

FIG. 4 illustrates an LCU and neighbor eight-direction pixels required to process a current LCU.

For the SAO processing apparatus to perform SAO processing based on a line unit 410, a “set of pixels of all of X values corresponding to a Y axial position of the current LCU and left and right reference pixels of an LCU block” may be defined as a line.

A line may be referred to as a first line or a second line based on the Y axial position. In the case of performing SAO processing based on the line unit 410, a single processing line and two reference lines may be used as an input for the SAO processing. An output may correspond to only pixels 430 included in an LCU in which SAO filtering is applied to a processing line may be regarded as an output.

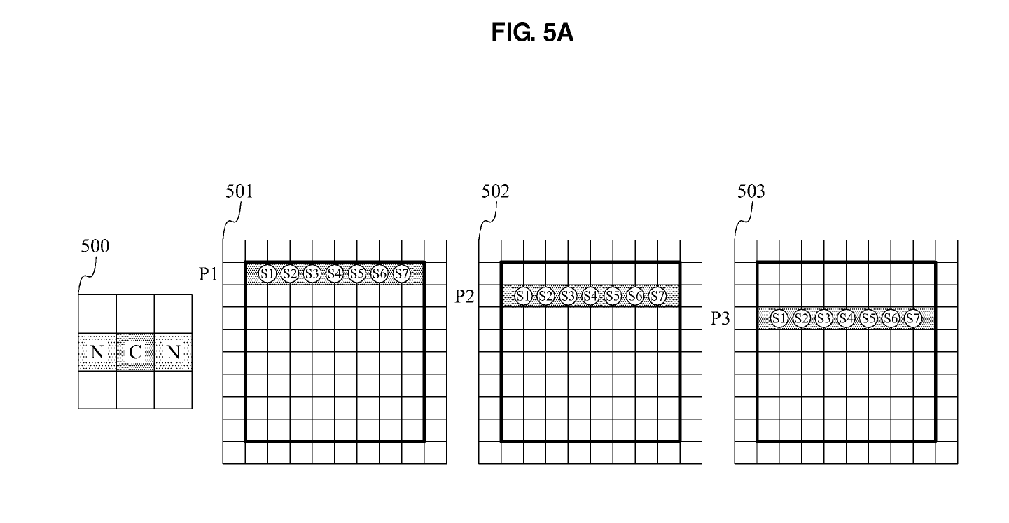

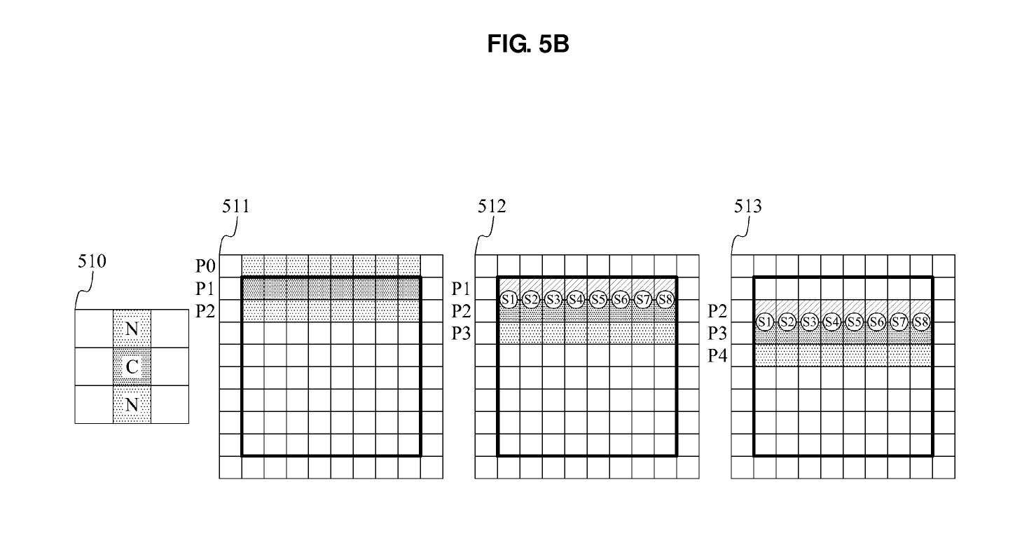

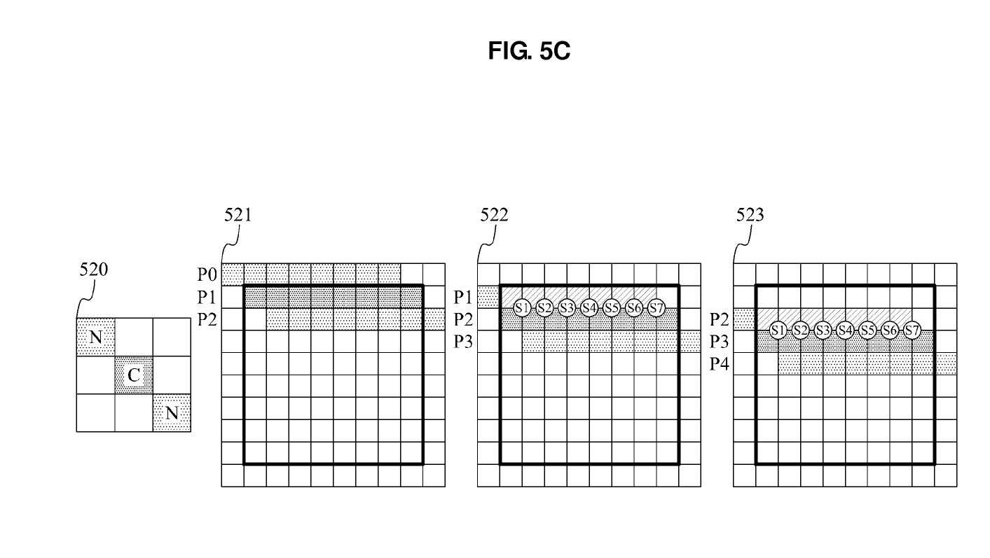

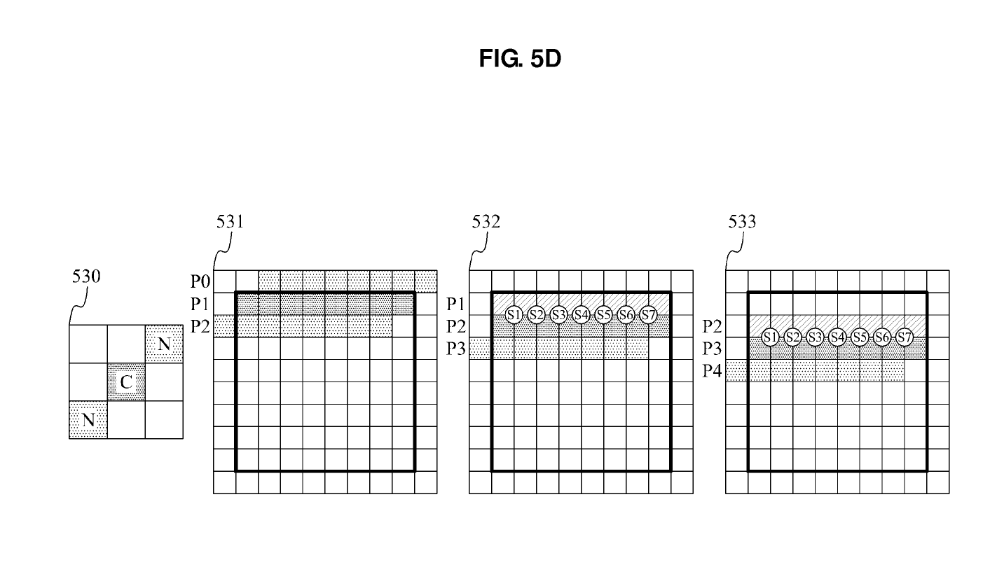

FIGS. 5A through 5D illustrate diagrams to describe an example of performing SAO processing by backing up a pixel and a code value in response to a SAO processed pixel being selected as a reference pixel in the case of performing SAO processing based on a line unit according to an embodiment.

In each of 501, 502, 503, 511, 512, 513, 521, 522, 523, 531, 532, and 533, inside of a bold line may be interpreted as an LCU, and outside of the bold line may be a neighbor pixel of the LCU and may be interpreted as a reference pixel to perform SAO processing on the current LCU.

FIG. 5A illustrates SAO type zero degrees 500, FIG. 5B illustrates SAO type 90 degrees 510, FIG. 5C illustrates SAO type 135 degrees 520, and FIG. 5D illustrates SAO type 45 degrees 530.

FIG. 5A illustrates an example of an edge offset (EO) method that refers to neighbor pixels in the case of the SAO type zero degrees 500.

In HEVC, SAO processing may be performed based on an LCU and encoding efficiency may be enhanced by adding an offset to a predetermined pixel. An SAO may be classified into an EO and a band offset (BO) based on a process of selecting a pixel to be added with an offset. An EO method may select a neighbor pixel based on a SAO type, may classify pixels into four categories based on a difference value between pixels, and may add a corresponding offset to a pixel value of a pixel included in each category.

In the case of performing SAO filtering based on a pixel unit, a code value of a difference between a left reference pixel and a right reference pixel based on a current pixel position needs to be known. However, since filtering on a previous reference pixel is already preformed, a code value of a difference between a left reference pixel and a processing pixel needs to be backed up in advance.

As illustrated in 501, 502, and 503 of FIG. 5A, in the case of performing SAO processing based on a line unit, pixels positioned on left and right at a current pixel position of zero degrees correspond to reference pixels and thus, a current line to be processed, that is, a processing line and a reference line may have the same characteristic. The processing line and the reference line are identical and thus, there is no need to back up an additional line unit.

FIG. 5B illustrates an example of performing SAO filtering in the case of the SAO type 90 degrees 510.

511 illustrates an LCU to be currently performed with SAO processing and a reference pixel.

P1 may refer to a pixel positioned at a boundary of the LCU and to which SAO processing is not performed. P2 may be positioned below P1 and refer to a pixel of a P1 position. However, SAO processing is already performed on the pixel of the P1 position and thus, the pixel of the P1 position may not be used as a reference pixel.

A category may be obtained by pre-storing a code of a difference value between P1 and P2 in a buffer in the case of performing SAO processing on P1, and by using a value having an opposite code in the case of performing SAO processing on P2. Also, a category of a P2 pixel may be determined by storing, in a buffer, a pixel value before filtering the pixel of the P1 position. Such pixel or pixel difference information may need to be stored based on a line unit up to a last LCU.

FIGS. 5C and 5D illustrate examples of an EO method that refers to neighbor pixels in the case of the SAO type 135 degrees 520 and the SAO type 45 degrees 530 using a similar method.

In the case of performing SAO processing based on a line unit, a first line may be an LCU boundary. To filter the LCU boundary, a pixel value before SAO filtering is performed may be backed up with respect to portions L, U0, U1, and U2 of FIG. 2B. As shown in 510, the SAO processing apparatus may perform SAO processing on a pixel corresponding to a first line, for example, P1 of the LCU.

As shown in 520 of FIG. 5C, the SAO processing apparatus may perform SAO process on a second line, for example, P2 of the LCU. A value of the first line P1 is added with an offset and thus, may not be used as a reference pixel. Accordingly, when a reference pixel or a code of a difference between two pixels is known, SAO processing may be performed at a current P2 position.

Similarly, as shown in 530 of FIG. 5D, when performing filtering on P3 after filtering on P2 is completed, a pixel value of P2 may be added with an offset. Accordingly, when information such as a pixel value before filtering of P2 is performed or a difference in a pixel value between P2 and P3 is pre-stored, SAO filtering may be performed.

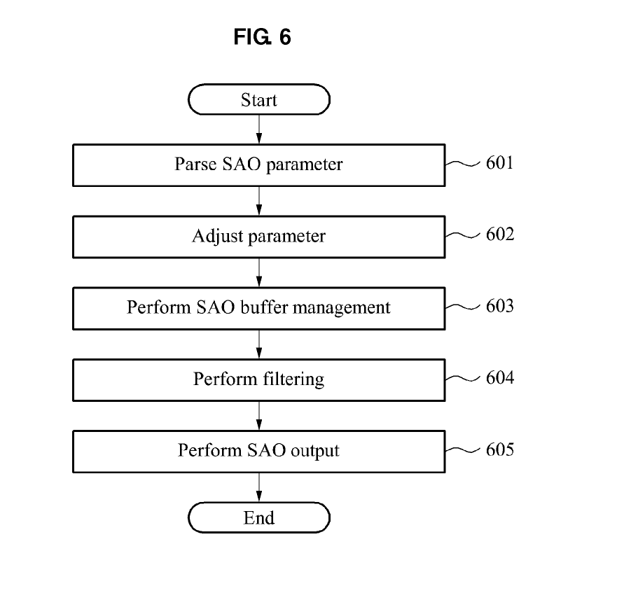

FIG. 6 illustrates an operation method of a SAO processing apparatus according to an embodiment.

In operation 601, the SAO processing apparatus may parse SAO parameter information from a bitstream using a SAO parameter parser.

In operation 602, the SAO processing apparatus may extract SAO type information and offset information from the parsed SAO parameter information using a SAO parameter adjuster.

The SAO processing apparatus may manage the extracted SAO type information and offset information using an SAO buffer manager in operation 603, and may perform filtering on the bitstream based on the SAO type information and the offset information using a filtering performer in operation 604.

In operation 605, the SAO processing apparatus may receive the SAO type information, and may extract a reference line and a processing line of the bitstream using the SAO buffer manager.

According to an embodiment, in the operation method of the SAO processing apparatus, the SAO processing apparatus may receive a request for pixel information required based on the SAO type information from the SAO buffer manager, and may load a reference pixel and a SAO processing pixel in response to the request, using a LCU/picture buffer.

According to an embodiment, in the operation method of the SAO processing apparatus, the SAO processing apparatus may determine whether a loaded pixel is a reference pixel or a SAO processing pixel using the SAO buffer manager, and may store the loaded pixel at a predetermined position of an input buffer based on the determination result.

According to an embodiment, in the operation method of the SAO processing apparatus, the SAO processing apparatus may receive information associated with at least one of a reference pixel and a SAO processing pixel from the SAO buffer manager, and may determine a category of a current pixel using the filtering performer. In this example, the SAO processing apparatus may apply an offset corresponding to the determined category to the SAO processing pixel using an offset value transferred from the SAO parameter adjuster using the filtering performer.

In the case of employing the operation method of the SAO processing apparatus according to embodiments, a previously used input pixel may be reused as a reference pixel and a processing pixel used for SAO processing of a subsequent line. Accordingly, the SAO processing apparatus may decrease memory load and minimize latency by moving a pixel to be reused to a corresponding buffer through buffer management and thus, may quickly perform SAO processing.

For example, in the case of separating an input buffer and an output buffer of SAO, and reusing a pixel value stored within the input buffer, the SAO processing apparatus may decrease memory load by moving a value to an input buffer of a corresponding position. Accordingly, the memory load may be decreased and a system processing rate may be enhanced.

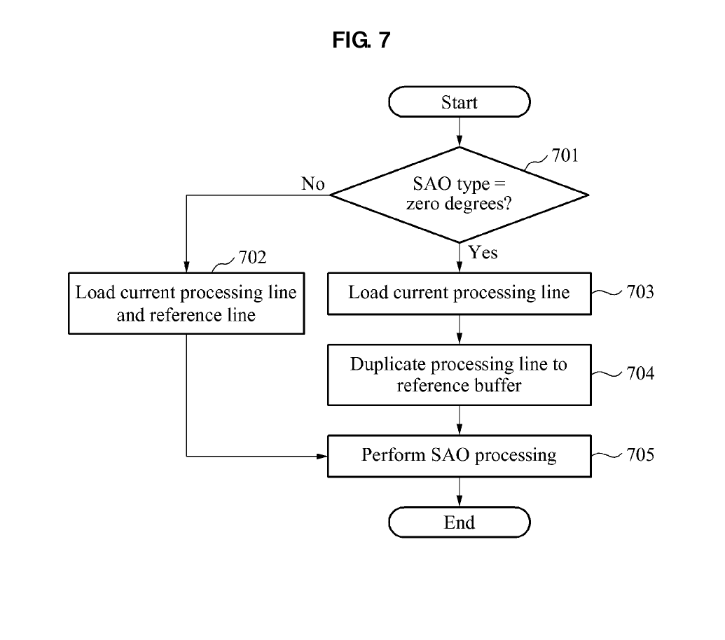

FIG. 7 illustrates a method of performing SAO buffer management based on a SAO type according to an embodiment.

When the SAO type is zero degrees, a position of a current pixel and a position of a reference pixel are present within the same line, which is different from a SAO type associated with a different EO. Accordingly, dependency may occur within a single line. In an operation method of a SAO processing apparatus according to an embodiment, an input and an output are separate from each other and thus, dependency may not be considered. However, in an input buffer, a reference pixel buffer and a processing pixel buffer are determined and thus, a current line pixel to be processed, that is, a current processing line pixel needs to be stored in the reference pixel buffer.

In operation 701, the SAO processing apparatus may verify whether a SAO type is zero degrees and may determine whether a position of a reference pixel is left or right.

When the SAO type is not zero degrees, the SAO processing apparatus may load a current processing line and a reference line to an input buffer in operation 702. For example, when the SAO type is 45 degrees, 135 degrees, or 90 degrees, the SAO processing apparatus may load the current processing line and the reference line to the input buffer and then perform SAO process in operation 705.

When the SAO type is zero degrees, the SAO processing apparatus may proceed to operation 703.

In operation 703, the SAO processing apparatus may load a processing pixel line from a memory since a current processing pixel line and a reference pixel line match.

In operation 704, the SAO processing apparatus may duplicate the processing pixel line that has loaded two pixels to the reference pixel buffer.

On the contrary, when the SAO type is not zero degrees, the SAO processing apparatus may load all of the current processing pixel line and the reference pixel line. Since the reference pixel and the processing pixel are provided, the SAO processing apparatus may perform SAO processing in operation 705.

The above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks, DVDs and Blu-rays; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be processed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A sample adaptive offset (SAO) processing apparatus, comprising:
a SAO parameter parser to parse SAO parameter information from a bitstream;
a SAO parameter adjuster to extract SAO type information and offset information from the parsed SAO parameter information; and
a filtering performer to perform filtering on the bitstream based on the SAO type information and the offset information.

2. The apparatus of claim 1, further comprising:
a SAO buffer manager to receive the SAO type information, and to extract a reference line and a processing line of the bitstream,
wherein the filtering performer performs filtering on the bitstream using the extracted reference line and processing line, together with the SAO type information and the offset information.

3. The apparatus of claim 2, further comprising:
a largest coding unit (LCU)/picture buffer to receive a request for pixel information required based on the SAO type information from the SAO buffer manager, and to load a reference pixel and a SAO processing pixel in response to the request.

4. The apparatus of claim 3, wherein the SAO buffer manager determines whether a loaded pixel is the reference pixel or the SAO processing pixel, and stores the loaded pixel at a predetermined position of an input buffer based on the determination result.

5. The apparatus of claim 2, wherein the filtering performer receives information associated with at least one of a reference pixel and a SAO processing pixel from the SAO buffer manager to determine a category of a current pixel.

6. The apparatus of claim 5, wherein the filtering performer applies an offset corresponding to the determined category to the SAO processing pixel using an offset value transferred from the SAO parameter adjuster.

7. The apparatus of claim 1, further comprising:
a SAO output unit to display a pixel of the filtered bitstream on an output screen, and to store the pixel of the filtered bitstream in an LCU/picture buffer.

8. The apparatus of claim 3, wherein the SAO buffer manager comprises:
a buffer management controller to determine whether an input to a buffer is to store a pixel moved from another input buffer or to store at least one of the reference pixel and the SAO processing pixel logged by the LCU/picture buffer.

9. An operation method of a sample adaptive offset (SAO) processing apparatus, the method comprising:
parsing, using a SAO parameter parser, SAO parameter information from a bitstream;
extracting, using a SAO parameter adjuster, SAO type information and offset information from the parsed SAO parameter information;
performing filtering, using a filtering performer, on the bitstream based on the SAO type information and the offset information, and
receiving, using a SAO buffer manager, the SAO type information to extract a reference line and a processing line of the bitstream,
wherein the filtering comprises performing filtering on the bitstream using the extracted reference line and processing line, together with the SAO type information and the offset information.

10. The method of claim 9, further comprising:
receiving, using a largest coding unit (LCU)/picture buffer, a request for pixel information required based on the SAO type information from the SAO buffer manager, to load a reference pixel and a SAO processing pixel in response to the request.

11. The method of claim 10, further comprising:
determining, using the SAO buffer manager, whether a loaded pixel is the reference pixel or the SAO processing pixel; and
storing the loaded pixel at a predetermined position of an input buffer based on the determination result.

12. The method of claim 9, further comprising:
receiving, using the filtering performer, information associated with at least one of a reference pixel and a SAO processing pixel from the SAO buffer manager to determine a category of a current pixel.

13. The method of claim 12, further comprising:
applying, using the filtering performer, an offset corresponding to the determined category to the SAO processing pixel using an offset value transferred from the SAO parameter adjuster.

14. The method of claim 9, further comprising:
displaying, using a SAO output unit, a pixel of the filtered bitstream on an output screen to store the pixel of the filtered bitstream in an LCU/picture buffer.

15. At least one non-transitory computer-readable medium storing computer readable instructions to control at least one processor to implement the method of claim 9.

16. An operation method of a sample adaptive offset (SAO) processing apparatus, the method comprising:
parsing SAO parameter information from a bitstream;
extracting SAO type information and offset information from the parsed SAO parameter information;
performing filtering on the bitstream based on the SAO type information and the offset information.

17. The method of claim 16, further comprising requesting pixel information based on the SAO type information and loading a reference pixel and a SAO processing pixel in response to the request.

18. The method of claim 17, further comprising determining whether a loaded pixel is the reference pixel or the SAO processing pixel and storing the loaded pixel in an input buffer when it is determined that the loaded pixel is the reference pixel.

19. At least one non-transitory computer-readable medium storing computer readable instructions to control at least one processor to implement the method of claim 16.
